(19) United States
(12) Patent Application Publication
(10) Pub. No.: US 2014/0268149 A1
(43) Pub. Date: Sep. 18, 2014

(54) DEVICE AND METHOD FOR DETECTION OF POLARIZATION FEATURES

(71) Applicant: University of Rochester, Rochester, NY (US)

(72) Inventors: James M. ZAVISLAN, Pittsford, NY (US); Christopher GLAZOWSKI, San Francisco, CA (US)

(21) Appl. No.: 14/215,560

(22) Filed: Mar. 17, 2014

Related U.S. Application Data
(60) Provisional application No. 61/793,921, filed on Mar. 15, 2013.

(51) Int. Cl. G01N 21/23

(52) U.S. Cl. CPC G01N 21/23
USPC 356/365

(57) ABSTRACT

An apparatus and method for imaging a section of a medium are disclosed. The section of medium has features (“Polarization Sensitive Features”) which return light according to the polarization of the received light. The disclosed apparatus and method may be configured to measure the irradiance of light returned from the object across the lateral (with respect to the optical axis) dimension.

### CROSS-REFERENCE TO RELATED APPLICATIONS

This application claims priority to the provisional patent application entitled “Device and Method for Detection of Polarization Features,” filed Mar. 15, 2013 and assigned U.S. App. No. 61/793,921, the disclosure of which is hereby incorporated by reference.

### STATEMENT REGARDING FEDERALLY SPONSORED RESEARCH

This invention was made with government support under contract numbers 5R42CA110226 and 5T32AR007472 awarded by the National Institutes of Health. The government has certain rights in the invention.

### FIELD OF THE INVENTION

The invention relates to imaging systems which are capable of detecting features of a medium which are responsive to polarized light.

### BACKGROUND OF THE INVENTION

Confocal microscopy is a well-established technology with sub-micrometer lateral (perpendicular to the optical axis) and micrometer longitudinal (parallel to the optical axis) resolution. In a typical biomedical setting, this provides optical images of sections of tissue for qualitative and quantitative cellular morphology, pathology, and chemical analysis. The contrast and resolution of these images allows them to be compared to the gold standard of histopathological preparation and viewing of sectioned and stained tissue.

The use of Nomarski techniques applied to confocal microscopy, and especially laser scanning confocal microscopy, is known to enhance the contrast of objects with phase variations or surface profile variations. Such differential interference contrast (“DIC”) microscopes split a uniform, linearly-polarized pupil such that two point spread functions form at the focus of the objective. This is accomplished using a birefringent prism, such as a Nomarski or Wollaston prism, placed at the pupil (or conjugate location to the pupil) of the microscope. The prism shears the beam into two beams and the orthogonally polarized pupils of the objective are focused to form two telecentric (in the object space) polarized spots. Upon reflection from the object, the sheared polarized beams are collected by the objective and re-combined at the pupil. Passing the recombined beam through a polarizing element provides an interference image, which is based on the phase profile of the scanned sample.

Such DIC configurations were previously improved by circularly-polarizing the sheared beams in order to further enhance the resulting image by reducing interference from turbidity above and below the section being imaged. See, for example, U.S. Pat. No. 6,577,394 to Zavislan, titled “Imaging System Using Polarization Effects to Enhance Image Quality.” FIG. 1 of the Zavislan patent depicts a prior art configuration of the polarization optics and objective of a microscope using a birefringement prism to shear a linearly polarized beam into two linearly polarized beams (having polarization orthogonal to each other) and a quarter wave plate retarder to circularly polarize the beams (opposite-handed polarization states).

By illuminating the sample with sheared beams having generally circular polarization in opposite senses (left and right handed circular polarization), images obtained using light returned from the image plane (i.e., a section within the sample), which may be altered by the sample's circular dichroism, retardation, etc., have reduced image distortion, such as that caused by scattering sites adjacent to the image plane or section.

In biological and tissue objects, there may also be polarization information in linear birefringence, linear di-attenuation, circular dichroism, etc. This information can supplement the morphology and reflectance data that has otherwise been captured. Many methods for gaining polarization sensitivity with a microscope have been investigated. Confocal microscopes have been designed to detect the light's state of polarization after reflection from the object. Although prior techniques have improved the usefulness of images produced, some image information related to polarization was ignored and the detection pathways of such instruments were generally treated as ellipsometers.

### BRIEF SUMMARY OF THE INVENTION

While previous efforts have utilized polarized-light techniques for reducing noise in a generated image, none have taken further advantage of the returned differential information to enhance images with details of Polarization Sensitive Features of the object being imaged. Accordingly, it is an objective of the present invention to provide improved imaging systems, such as, for example, imaging systems using confocal microscopy, laser scanning confocal microscopy, scanning reflectance confocal microscopy, etc, that can generated images having information related to the Polarization Sensitive Features of an object. The disclosed apparatus and methods are configured to measure the irradiance of light returned from the object across the lateral (with respect to the optical axis) dimension.

### DESCRIPTION OF THE DRAWINGS

For a fuller understanding of the nature and objects of the invention, reference should be made to the following detailed description taken in conjunction with the accompanying drawings, in which:

FIG. 1 is a diagram showing the optics of a scanning reflectance confocal microscope (“SRCM”) according to an embodiment of the present invention;

FIG. 2A is a diagram depicting the illumination pathway and detection pathway for an SRCM;

FIG. 2B is a diagram depicting the illumination pathway and detection pathway for an SRCM with a modified detection arm, incorporating extra polarization elements.

FIG. 3A is a diagram showing the arrangement of a detector to detect the spatial distribution of light received at the focus of the detector lens;

FIG. 3B is a diagram showing the arrangement of a detector behind a pinhole spatial filter to detect the spatial distribution of light received at the focus of the detector lens;

FIG. 3C is a diagram showing the arrangement of a detector array to detect the spatial distribution of light received at the focus of the detector lens where only detector elements within a circle centered on the optical axis are used to detect the spatial distribution of light received at the focus of the detector lens;

FIG. 4A is a diagram showing the arrangement of a fiber bundle to detect the spatial distribution of light received at the focus of the detector lens;

FIG. 4B is a diagram showing the arrangement of a segmented optic to relay the spatial distribution of light received at the focus of the detector lens to three separate detectors;

FIG. 5 is a flowchart showing a method according to another embodiment of the present invention;

FIG. 6A is a diagram is illustrating a system for the detection of polarization features within a fiber-based OCT or OCM system;

FIG. 6B is a diagram illustrating a system for the detection of polarization features within a Michelson or Linnik configuration of an OCT or OCM system;

FIGS. 7A-7F is a series of polarization traces of the NR-DIC eigenstates wherein: (a) Incident linear, horizontal polarization; (b) after the DIC prism, the states are sheared into ±45° linear states; (c) a quarter-wave retarder oriented with its fast axis along the x-axis, will generate left (dashed) and right (solid) circular polarization states; (d) after reflection at the object the states reverse handedness; (e) after traversing the quarter-wave retarder the circular states are converted to linear-states that are orthogonally oriented to their input states in (b); the DIC prism does not recombine these orthogonal states; (f) a linear, vertical analyzer in the detection arm of the SRCM will pass the projections of the sheared states along its pass-axis (these states have a 180° phase difference);

FIGS. 8A-8D depict modeled pinhole irradiance distribution versus linear birefringence, wherein the birefringence phase is: (a) 0°; (b) 45°; (c) 90°; and (d) 180° differential phase between orthogonal axes (with the object birefringence retardation axis oriented at 45° to the x-axis; along the direction of shear);

FIG. 9A is a graph showing the relative distribution of energy between the outer (left and right) point spread functions PSFs and the center point spread function PSF (as the object's birefringence is increased, more energy is directed to the center PSF); retardation axis is along the x-axis;

FIG. 9B is a graph showing the relative electrical phase of left (upper dashed line), right (lower dashed line) and center (circles) PSFs for a birefringent object rotating from −45° to 45° (illustrating that the center channel is either in phase with the left or right PSF's electric field depending on the object's orientation (shown) or sign of birefringent phase (positive or negative, not shown, but inferred));

FIG. 10 is a graph showing the modeled split-pinhole metric versus increasing amounts of phase birefringence wherein the legend indicates the rotation of the birefringence axis from 0° (along the x-axis);

FIG. 11 is a graph showing the modeled split-pinhole metric versus orientation of the optic-axis for small amounts of phase birefringence, wherein the legend indicates the amount of phase birefringence;

FIG. 12 is a graph showing the modeled split-pinhole metric versus orientation of the optic-axis for larger amounts of phase birefringence, wherein the legend indicates the amount of phase birefringence;

FIG. 13 is a graph showing the modeled split-pinhole metric versus orientation of the optic-axis for small amounts of phase birefringence after translation of the DIC prism to add π/2 phase between the output polarization states—having the effect of translating the trend lines along the x-axis (the legend indicates the amount of phase birefringence);

FIGS. 14A-14D depict modeled circular dichroism pinhole irradiance evolution for: (a) α_{L}=1; (b) α_{L}=0.75; (c) α_{L}=0.5; and (d) α_{L}=0;

FIG. 15 is a graph showing the modeled split-pinhole metric for increasing amounts of circular dichroism, wherein the x-axis is 1−α_{L,R}; 0—no dichroism: 1—complete absorption;

FIGS. 16A-16D depict di-attenuation pinhole irradiance evolution for di-attenuation in either the x or y direction: (a) η=1.0; (b) η=0.5; (c) η=0.1; and (d) η=0.0; and

FIG. 17 is a graph showing the energy distribution between fully separated “left,” “right,” and “center” channels for increasing diattenuation; diattenuation axis oriented at 45 degrees (quadrant 1 of x-y plane).

### DETAILED DESCRIPTION OF THE INVENTION

The present invention may be embodied as an apparatus 10 for imaging a sample of a medium 90, which may be a turbid sample. The apparatus 10 may be, for example, a scanning reflectance confocal microscope (“SRCM”), such as that depicted in FIG. 2A. The sample can be a section of dermatological tissue. The section being imaged, especially in imaging of biological tissue, may be of the thickness of a cell, for example about five microns. Thick biological tissue is a volume object, and information exists at various depths, dimensions and spatial frequencies. As an optically dense material, it scatters most of the incident light throughout its depths. SRCMs optically section thick tissues by preferentially collecting scattered light from a selected depth to form an image that maps the physical structure of the tissue at that location. A medium may contain multiple features, each of which may have an appearance that varies depending on the polarization of incident light (so-called “Polarization Sensitive Features”). For example, a section of dermatological tissue may contain, among other things, Langerhans cells, nerve fibers, elastin and collagen. Each of these may return light differently depending on the polarization of the incident light.

In such an apparatus 10, light is received at the medium 90 and illuminates a section of the medium 90. Reflected light is returned from the section and from sites adjacent to the section. The apparatus 10 comprises an optical system 12 for directing light to the medium 90 (“received light”) and directing light from the medium 90 (“returned light”). In some embodiments, the light directed to the medium 90 may be laser light provided by a single spatial mode laser 92.

The optical system 12 is configured to shear the illuminating beam provided by the laser 92 into two beams of differing polarization as is known in the art. For example, in some embodiments, the light from the laser 92 is linearly polarized and passes through polarization processing optics 32. Referring back to the exemplary prior art embodiment depicted in FIG. 1, the polarization processing optics 32 may comprise a prism 42, such as a Wollaston or Nomarski prism. The polarization 46 of the incident beam 56 contains components of polarization parallel to both optical axes of the prism sections 50, 52, and the prism 42 splits or shears the incident beam 56 into two linearly polarized beams A, B. The axes of polarization for the two beams A, B are parallel to each of the optical axes of the two sections 50, 52 of the prism 42. Both beams A, B pass through a quarter-wave phase retarder or quarter-wave plate 44. The quarter-wave plate 44 causes the beams A, B to be, for example, circularly polarized in opposite senses (opposite-handed). This combination of prism 42 and retarder 44 aligned as described is termed non-reversible differential interference contrast or NR-DIC

The beams A, B are directed through an objective 30 and are focused in the medium 90 at spots C, D which are spaced from each other in the focal plane (in the image section of interest) and/or along the optical axis (not shown). In some embodiments of the present invention, the location for the prism 42 is the aperture stop of the objective or at pupil of the optical system. The beams A, B generally overlap outside of the focal region such that both beams illuminate the noise-producing scatterers outside (above and below) the focal region. Because the overlapping region above and below the focal region are illuminated by orthogonally polarized beams, light scattered from isolated scatters outside the focal region is partially canceled by destructive interference. Consequently, any collected signal is reduced by the interference of the light returned from the scattering sites outside of the focal region. However, circular dichroism, optical retardance, di-attenuation and other optical activity also exist and may manifest as differences between the light returned from the spots C, D. Thus, this imaging mode provides a preferential and differential polarization sensitive signal from the focal region. The polarization sensitive signal at the focal region is not strongly influenced be polarization properties of the object above it as is the case in polarization sensitive optical coherence tomography. (J. de Boer et al, Two-dimensional birefringence imaging in biological tissue by polarization-sensitive optical coherence tomography, Optics Letters, Vol. 22, Issue 12, pp. 934-936 (1997) http://dx.doi.org/10.1364/OL.22.000934). Thus, this imaging mode provides the preferential ability to measure the polarization properties of isolated structures within an object.

The light is returned from the medium 90 and collected by the objective 30. The polarization components of each of the angularly sheared return beams that are orthogonally polarized to the original incident sheared beams are not recombined into a single beam, but instead are re-sheared by the prism 42. The optical system 12 of an apparatus 10 of the present invention further comprises a pinhole lens assembly 16 configured to receive the returned light. The pinhole lens assembly 16 is located after a beamsplitter 20 such that returned light is directed to the pinhole assembly 16. In such embodiments of NR-DIC operation, the ensemble of the DIC prism plus quarter-wave-plate is operated between crossed linear polarizers; a linear analyzer is used prior to the pinhole lens that is crossed relative to the initial laser polarization. This is be done, for example, by using a beam splitter 20 that transmits linear polarization of one orientation and reflects the orthogonal linear polarization. Such a beamsplitter is termed a polarizing beamsplitter (“PBS”).

Alternatively, as shown in FIG. 2B, beam splitter 20 may be a non-polarizing beam splitter (“NPBS”) that transmits or reflects orthogonal linear polarization states with nominally equal amplitudes. When beamsplitter 20 is an NPBS, a linear analyzer is used prior to the pinhole lens that is crossed relative to the initial laser polarization.

It should be noted that if the beamsplitter 20 is an NPBS, a mechanically-adjustable waveplate 149, such as, for example, a Babinet-Soliel retarder, or an electrical adjustable waveplate, such as, for example, a voltage controlled liquid-crystal retarder, can be placed after the NPBS and prior to the analyzer. The retardation axis of the adjustable waveplate may be oriented at 45 degrees. This adjustable retarder can combined with a linear analyzer 150 to provide for a fully ellipsometric analysis of the two return light beams and the light in the area of overlap between the two beams.

Because the prism 42 re-shears light that is orthogonally polarized as it traverses the prism 42 toward the pinhole 16 and recombines the light coincidentally polarized, the spatial distribution of the light in the pinhole 16 depends on the modification of the incident polarization by the object 90. The polarization modifications of interest are, again, linear birefringence, di-attenuation (linear dichroism) and circular dichroism.

The apparatus 10 comprises a detector 60 configured to receive the returned light from the pinhole lens assembly 16. The detector 60 has at least two sensors 61, each sensor 61 configured to receive a portion of the returned light. Each sensor 61 may be, for example, a photo diode. For example, two sensors may be configured as a split photodetector and each sensor 61 may be configured to receive a portion of the returned light that corresponds to one of the beams of light. In another example, a detector has three sensors, two of which are configured to receive a portion of the returned beams and the third being configured to receive a portion of the returned light between the positions of the two beams or wherein the beams overlap.

In another example, a detector has four sensors, the outer two elements of which are configured to receive a portion of the returned beams, and the center two elements are configured to receive a portion of the returned light between the positions of the two beams or wherein the beams overlap. Such a detector configuration 161 (as viewed from the detector lens) is shown in FIG. 3A. The space between the center two sensor elements 190 is nominally centered with respect to both the optical axis of the imaging system and the center of the pinhole. Each of the detector elements 61 is arranged along a line 192. Line 192 is parallel to the image of the line connecting spots C and D in FIG. 1. Equivalently, line 192 passes through the center of the images of spots C and D at the detector focus.

In yet another example of a detector suitable for the disclosed apparatus, the detector may have an array of sensors, such as an avalanche photodiode array, a charge coupled device (“CCD”), or complementary metal-oxide-semiconductor (“CMOS”) image sensor. The size and spacing of the sensor elements can be varied across the detector array to optimize the filling of each of the sensor elements with each beam or the area overlap between the beams. In this way, the apparatus 10 is configured to detect the spatial distribution of light received at the focus of the detector lens and from the spatial distribution detect the differences in polarization response of the section of the medium 90. In other words, the detector differentiates the light returned from the Polarization Sensitive Features of the medium 90. Additional types of “split detectors” (detectors having more than one sensor) may be suitable for use with the present disclosure.

In one embodiment, the pinhole lens assembly comprises a detector lens that images the spots C and D at or within the object to a pinhole that acts as a spatial filter. The size of the pinhole is typically expressed in relationship to the size of a diffraction limited spot that would be formed at the focus of the detector if the object were replaced by a mirror, placed at the beam waist of the incident illumination. A pinhole aperture of diameter equal to one diffraction limited spot presented at the focus of the detector lens is termed a one-resolution element or one resolution pinhole. Typically, pinhole diameters of one to nine resolution elements are used in laser scanning confocal microscopes. Because the prism 42 produces two sheared spots at the object, the size of one resolution element at the pinhole is increased by the amount of shear scaled by the optical magnification between the objective lens focus and detector lens focus.

Detector elements can be placed behind the pinhole and within one depth of focus of the detector lens, for example, as illustrated in FIG. 3B with a four-element detector array. Here only the edge of the pinhole 180 is shown for clarity. Alternatively, the light leaving the pinhole can be imaged with or without magnification onto the detector elements. In some embodiments, the linear area separating the detector elements is rotationally adjusted to be nominally perpendicular to the line connecting the images of spots C and D in the detector lens focus.

In another embodiment, the detector lens focuses light onto a sensor array without a pinhole, for example, as shown in FIG. 3C. A two-dimensional sensor 261, such as, for example, a CCD or CMOS image sensor, is composed of many sensor elements 61. The light signal striking each element 61 can be measured and extracted from the array. Detector elements 63 that fall inside a virtual pinhole 280 are indicated by diagonal hash. Only detector elements 63 would need to be analyzed to determine the spatial distribution of the light at the focus of the detector lens. The size, number. and arrangement of the sensor elements may be selected so that, by collecting the signals from selected sensors elements, the spatial distribution of light received at the focus of the detector lens, and from the spatial distribution detects the differences in polarization response of the section of the medium 90.

In yet another embodiment, a fiber optic array can be placed at the focus of the detector lens to collect the spatial distribution of light. Individual fibers 380 in an array 382 can be routed to individual detectors 61 as shown in FIG. 4A. Fiber optic arrays can be made by fusing a collection of circular core, square core, rectangular core, or hexagonal core fibers at one end and allowing the other end of the fibers to be separately routed to detector elements. Collimated Holes, Inc., 460 Division Street, Campbell, Calif. 95008 is one supplier of such fiber arrays. The fiber arrays can be used to collect light directly from the light 120 focused by the detector lens or light that has been transmitted through a pinhole at the focus of the detector lens. Alternatively, the light passing through the pinhole can be relayed with or without magnification onto the fiber array.

In another embodiment, a segmented optic can be placed at the focus of the detector lens or at a relayed image behind a pinhole to collect the spatial distribution of light and distribute it to a collection of individual detectors. An exemplary geometry of a segmented optic and its detectors is shown in FIG. 4B. Light 120 focused by the detector lens is incident on a pinhole spatial filter 80. Light transmitted through the pinhole is incident on a segmented optic, which is composed of an extruded isosceles trapezoid 250 with surfaces E, F, G, H. The isosceles trapezoid may be, for example, a solid glass or plastic prism or an assembly of two mirrors with a central gap. The width of surface G is set to transmit a portion of the returned light between the positions of the two beams or wherein the beams overlap. The light transmitted by surface C may be directed to a detector 61. In this way, surfaces F and H intersect a portion of the returned light that corresponds to each of the beams of light. Surfaces F and H can be coated to reflect the intersected light toward two separate detectors. In other embodiments, surface G can be canted and coated to reflect the light to an off-axis detector. Additionally, surface G can be split to form a roof edge so that the center light distribution can be directed to two detectors rather than one detector. Such a segmented optic with four detectors would be equivalent to the configuration shown in FIG. 3B. The segmented optic provides for the selective redistribution of the spatial distribution light across the focus of detector lens or a subsequent relayed image of the detector lens focus to three detectors that detect the differences in polarization response of the section of the medium 90.

Each sensor 61 of the detector 60 produces an electrical signal in response to the portion of the returned light received by the sensor 61 from the pinhole assembly 16. The electrical signal of the detector 60 varies according to characteristics of the light received at the detector 60. The amplitude of the electrical signal may be considered to be generally proportional to the reflectance of the section. In some embodiments, the electrical signal may vary according to a polarization parameter of the received light, such as, for example, the amount and orientation of linear birefringence, the amount of linear dichroism, or di-attenuation, and/or the amount of circular dichroism within the section.

The apparatus may further comprise a processor 62 in communication with the sensors 61 of the detector 60. The processor 62 is programmed to generate an image of the section based on the electrical signal of the sensors 61. The generated image may include image information of the Polarization Sensitive Features. The medium 90 can be scanned by the apparatus in any manner. In the exemplary embodiment depicted in FIG. 2, a rotating polygon is provided for x-axis scanning and a galvanometric mirror is used for y-axis scanning. Other configurations, using, for example, undulating mirrors, pivoting mirrors, or otherwise can be used. These scanning optics provide scanning in the X and Y directions, where X and Y are coordinates orthogonal to each other in the image plane. The scanning optics are controlled by a controller, which may be processor 62 or a controller separate from processor 62. In some embodiments, the medium 90 is scanned by moving the objective lens using actuators. Scanning may also be performed in the Z direction. It will be appreciated that spots C, D can be scanned in X, Y, and Z over the image plane in order to provide optical signals from which the image can be constructed by the processor 62 after detection by the sensors 61 of the detector 60.

The present invention may also be embodied as a method 100 of imaging a section of a medium, the section having Polarization Sensitive Features (see FIG. 5). In this way, as previously described, the section contains features which return light according to the polarization of the received light. The method 100 comprises the step of directing 103 light in beams of different polarization to the medium along an optical axis. The directed 103 beams may be polarized in any way, including, for example, shearing a single linearly polarized beam using a birefringent prism and using a quarter wave plate retarder to cause each sheared beam to have opposite circular polarizations. The beams may be caused to overlap in the medium to reduce the portion of the light returned from the sites adjacent to the section and spaced generally along the optical axis. The beams may be directed 103 such that the beams are incident in the medium at spots spaced from each other along the optical axis. The beams may be directed 103 such that the beams are incident in the medium at spots spaced laterally from each other in a focal plane.

The light incident on the medium is returned by the section (at an image plane) and also from sites adjacent to the section. The light returned from the medium is directed 106 to a detector by way of a birefringent component, such as a prism, wherein polarization components the sheared beams are not recombined. In this way, the beams of light reaching the detector are differentiated according to each beam's light returned from the Polarization Sensitive Features. The direction 106 may be provided by, for example, an optical assembly as described above. The method 100 comprises the step of detecting 109 the differentiation of the beams of returned light received at the detector. For example, the returned light at more than one lateral position of the returned light (with respect to the optical axis) may be detected by a different sensor of the detector such that the detector can sense the differences across the returned light. The sensors may be configured to detecting portions of returned light having the response of a Polarization Sensitive Feature, the sensors may be configured to detect portions having overlapping responses, or the sensors may be configured differently (such that some detect overlapping responses and others do not).

An image of the section is generated 112 from the detected 109 returned light. The generated 112 image may correspond to a polarization parameter of the returned light and include information of the Polarization Sensitive Features. The polarization parameter may be any characteristic of interest to the operator. For example, in some embodiments, the polarization parameter is the amount and orientation of linear birefringence within the section. In other embodiments, the polarization parameter is the amount of linear dichroism within the section. In other embodiments, the polarization parameter is the amount of circular dichroism within the section. Embodiments may include more than one type of response.

It should be noted that the benefit of providing NR-DIC optics along with configuring the sensors elements to detect portions of returned light having the response of a Polarization Sensitive Feature can be applied to optical coherence tomography (“OCT”) imaging systems. OCT systems provide images within tissue by collecting the light scattered from the tissue and interfering it with light from a reference arm. Optical coherence tomography systems are known (D. Huang, et al. “Optical coherence tomography, Science vol. 254, pgs. 1178-1181, 1991; J. M. Schmitt, A. R. Knuettel, A. H. Gandjbakhche, R. F. Bonner, “Optical characterization of dense tissues using low-coherence interferometry”, SPIE Proceedings, vol. 1889 pgs 197-211, July 1993; Handbook of Optical Coherence Tomography, B. Bouma and G. J. Tearney, eds, Markel Dekker, NY (2002) ISBN 0-8247-0558-0; M. Choma, M. Sarunic, C. Yang, and J. Izatt, Sensitivity advantage of swept source and Fourier domain optical coherence tomography, Optics Express, Vol. 11, Issue 18, pp. 2183-2189 (2003), http://dx.doi.org/10.1364/OE.11.002183). OCT systems use time domain, Fourier domain, and swept wavelength source methods to provide interference-based detection as described in Bouma and Tearney (2002) and by Choma et al. (2003). Images can be acquired by: (1) mechanically translating the tissue relative to the optical system; (2) mechanically translating the complete optical system or just the objective relative to the tissue; (3) optically scanning the object illumination beam relative to the optical axis of the objective; (4) imaging the object on to a one-dimensional or two-dimensional detector array; or a combination of (1), (2), (3) and/or (4). Systems that optically scan the object illumination beam are sometimes referred to as optical coherence microscopes (H. Wang, J. A. Izatt and M. D. KulKarni, “Optical Coherence Microscopy” chapter 10 (pgs. 275-298) and H Saint-Jalmes, et al. “Full-field optical coherence microscopy” chapter 11, (pgs. 299-334) Handbook of Optical Coherence Tomography, B. Bouma and G. J. Tearney, eds, Markel Dekker, NY (2002) ISBN 0-8247-0558-0) and can provide images with lateral resolution comparable to confocal microscopy.

Polarization sensitive OCT imaging systems have been developed. (J. de Boer et al, Two-dimensional birefringence imaging in biological tissue by polarization-sensitive optical coherence tomography, Optics Letters, Vol. 22, Issue 12, pp. 934-936 (1997) http://dx.doi.org/10.1364/OL.22.000934). These systems do not utilize the NR-DIC assembly of prism 42 and waveplate 44. Additionally, such previous systems do not utilize the spatial distribution of the light at the detector lens that is returning from the object.

The improved imaging provided by NR-DIC with spatial detection can be incorporated both in scanning spot or scanned object OCT or OCM as well as full-field OCM systems. FIG. 6A illustrates a schematic of a scanning spot/scanned object OCT or OCM system utilizing a single spatial mode illuminator in the object arm. Illumination can be provided by a broad-band superluminescent diode, femto-second laser, super continuum source, or swept wavelength source coupled into optical fiber. The optical fiber may be a single mode fiber. Photonic crystal fiber may be used. In the figure, optical fibers are shown with arrows and communication or control signals are shown without arrows. Light from the source 192 is divided into an object arm 112 and reference arm 132 by a fiber-based splitter 121. The fiber-based splitter 121 has one input fiber and two output fibers. In one embodiment, the fiber-based splitter 121 directs approximately 90% of the output power into the fiber directed to the object arm 112 where the light leaves the fiber and is collimated by a lens. The remaining output power can be phase modulated by phase modulator 134 and then split evenly and coupled into four fibers by one to four fiber couplers 4 for use as reference arms.

Within the object arm, the collimated light is directed through a beamsplitter 120 and into a NR-DIC system comprising a Nomarski or Wollaston prism followed by a quarter-wave plate placed at either the aperture stop of the objective or at a pupil of the objective. In one embodiment, the beamsplitter 120 is a polarizing beamsplitter. Because these systems use broadband light, the quarter-wave plate, beamsplitters, and fiber splitters used in OCT or OCM systems may be designed for the wavelength range used. The NR-DIC assembly produces two sheared, orthogonally circularly polarized beams that are focused to two sheared beam waists within the sample 190. Light scattered within the tissue is collected by the objective and is retransmitted through the NR-DIC system. Light orthogonally polarized to the incident light will be reflected by the beamsplitter where it is focused through a detector lens onto a four-element fiber bundle 384. The fibers of the fiber bundle are oriented so that a line connecting the centers of the fibers is parallel with a line connecting the images of spot C and D. Each fiber collects a portion of the spatial light distribution at the focus of the detector lens. Each of the four fibers from the object arm are combined with one of the four reference arm fibers with a two to one fiber coupler 2. Light from each of the sampled spatial areas in object arm 112 mixes with light from the reference arm 132 by way of the fiber splitter to enable an interference signal that is detected by one of four detectors 160. Thus, the amplitude and phase of each sampled spatial area can be detected using standard OCT or OCM reconstructions by a processor 162. From this reconstructed signal, polarization sensitive features can be determined by the processor 162 or by a separate processor 163.

Fiber-based or free space polarization rotators or analyzers may be incorporated in the source, object, reference, and detection fibers to enable balanced detection. The specific detector and detection algorithm depends on the type of OCT: time domain, Fourier domain, or swept wavelength source. The detector is interfaced with a processor 162 that extracts the information associated with the object being imaged. The processor 162 may be interfaced to an additional processor 163 that controls the translation of the scanning system of the optical system or tissue as well as providing the necessary control signals to the reference arm and the illumination source. Processor 163 may have the ability to display, store, and/or transmit images.

FIG. 6B illustrates an embodiment of a full-field optical coherence microscope that incorporates polarization feature detection. The optical arrangement follows the geometry of a Linnik interferometer. A source 292, which may be a broad-band area source, is directed into a non-polarizing beam splitter 220. Light from the source 292 is split into two arms: a reference arm 232 and an object arm 212. Light directed to the object arm is transmitted through an NR-DIC assembly to produce two sheared, orthogonally circularly polarized fields incident on object 290. The shear prism in the NR-DIC assembly may be placed at the aperture stop of the objective 230 or at a pupil of the object arm. As mentioned above, because this system uses broadband light, the quarter-wave plate and beamsplitter used may be designed for the wavelength range used. For each point in the object section being imaged, there are two orthogonally circularly polarized beams that overlap at each object point. In an embodiment, the object section being imaged is located at the focal point of the object arm objective 230. Light scattered from each point in the object is collected by the objective 230, passed through the NR-DIC optics, and directed toward an area detector 260 through non-polarizing beam splitter and a detector lens 212.

The optical arrangement of the reference arm is similar to the object arm. Light directed to the reference arm is transmitted through an NR-DIC assembly to produce two sheared, orthogonally circularly polarized fields incident on reference mirror 250. The shear prism in the NR-DIC assembly may be placed at the aperture stop of the objective 231 or at a pupil of the reference arm. For each point on the reference mirror being imaged, there are two orthogonally circularly polarized beams that overlap at each reference mirror point. In the preferred embodiment, the mirror surface being imaged is located nominally at the rear focal point of the reference arm objective. Light scattered from each point at the reference mirror is collected by the objective 231, passed through the NR-DIC optics, and directed toward an area detector 260 through the non-polarizing beam splitter and detector lens 212. Light from the object arm 212 is mixed with light from the reference arm 232 by the beamsplitter 220 to enable an interference signal that is detected by a detector 260. A linear polarization analyzer may be placed in the detection arm and the azimuth of the analyzer adjusted to balance the detection of the object and reference arms. In an embodiment, the detector 260 is placed at the rear focal point of the detector lens. The NR-DIC optics in both the reference arm and object arm are placed at aperture stop of the respective objectives or at a pupil of the objectives. The NR-DIC and objective assemblies of both the object and reference arms are positioned such that the pupils of both the reference and object arms coincide with the front focal point of the detector lens. To extract information associated with object, the reference arm may be phase modulated. In an embodiment, the reference mirror is moved in steps of λ₀/4 where λ₀ is the mean wavelength of the illumination spectrum normalized by the detector responsivity. Irradiance from the detector is captured at three or more measurements taken at consecutive mirror motion steps and processed to extract the phase and amplitude of the light scattered from a section located in the front focal point of the object arm objective. The processing follows that of known phase extraction techniques (J. C. Wyant, Computerized interferometric measurement of surface microstructure, SPIE Proceedings vol. 2576, pgs 122-130 (1996)). The detector is interfaced with a processor 262 that extracts the information associated with the object being imaged. The processor 262 may be interfaced to an additional processor 263 that controls the translation of the optical system to select the depth of imaging (z) within the tissue or the specific (x,y) location of the tissue as well as providing the necessary control signals to the reference arm mirror translator and the illumination source. Processor 263 preferably has the ability to display, store and transmit images.

In embodiments where the detector 260 is an area detector such as a CMOS or CCD imaging array, the magnification and numerical aperture (NA) of the objective may be matched with the pixel size and spacing of the array, such that there are at least two pixel elements across each optical resolution element or resolution at the detector. In some embodiments, rectangular pixel elements may be used, such as those found in some linear CMOS or CCD imaging sensor arrays. These arrays could be used to create an area image by optically or mechanically scanning to create a two dimensional image.

Discussion of Mechanism

The following discussion is intended to be a non-limiting illustration of a mechanism by which the present invention operates. In some embodiments of NR-DIC operation, the ensemble of the DIC prism plus quarter-wave-plate is operated between crossed linear polarizers; a linear analyzer is used prior to the pinhole lens that is crossed relative to the initial laser polarization. This can be done by using a beam splitter 20 that transmits linear polarization of one orientation and reflects the orthogonal linear polarization. Such a beamsplitter is termed a polarizing beamsplitter (“PBS”). Alternatively, as shown in FIG. 2B beam splitter 20 may be a non-polarizing beam splitter (“NPBS”) that transmits or reflects orthogonal linear polarization states with nominally equal amplitudes. When beamsplitter 20 is an NPBS, a linear analyzer may be used prior to the pinhole lens, that is crossed relative to the initial laser polarization.

It should be noted that if the beamsplitter 20 is an NPBS, a mechanically-adjustable waveplate 149, such as, for example, a Babinet-Soliel retarder, or an electrical adjustable waveplate, such as, for example, a voltage controlled liquid-crystal retarder, can be placed after the NPBS and prior to the analyzer. The retardation axis of the adjustable waveplate may be oriented at 45 degrees. This adjustable retarder can combined with a linear analyzer 150 to provide for a fully ellipsometric analysis of the two return light beams and the light in the area of overlap between the two beams.

In the embodiments having a crossed linear analyzer, the orthogonal, sheared polarization states produce projections along the analyzer direction that are 180-degrees out of phase. In the following analysis, the x direction is parallel to the line connecting the spots C and D. The y direction is perpendicular to the line connecting the spots C and D. The z direction is locally parallel to the optical axis of the objective lens and detector lens. The focusing optical elements are assumed to be centered and rotational symmetric. This coordinate system is generally rotated about the z-axis 45 degrees from that shown in FIG. 1. See FIGS. 7A-7F for an illustration of the polarization changes that a specularly reflected beam will encounter in the NR-DIC configuration. In irradiance, this will yield a similar bi-lobed PSF like TEM₁₀. Because the spots are of opposite phase after the linear analyzer, the spots would completely cancel each other if they were to completely overlap. As the angular shear of the prism is increased, two lobes begin to appear, with increasing irradiance, because more of the PSF do not overlap and cancel. Then, when the spots approach a separation of more than their diameter, they appear as two distinct spots.

The expected polarization response of a system using NR-DIC techniques can be calculated by tracing its polarization properties in a formalism known as Jones calculus. Any coherent, fully-polarized beam can be decomposed into components of orthogonal polarization. The state of polarization can be represented by a vector containing the magnitude and phase of these two orthogonally polarization states,

$$\underline{U} = [ \begin{matrix}\vert {U}_{x} \vert & {e}^{iϕ x} \\ \vert {U}_{y} \vert & {e}^{iϕ y}\end{matrix} ] \qquad ( 1 )$$

where |Ux| and |Uy| are the magnitudes of the x- and y-polarized components and φₓ and φ_{y} their respective phases. The input polarization of our SRCM is x-polarized. This can be represented by the normalized vector

$${\underline{U}}_{in} = [ \begin{matrix}1 \\ 0\end{matrix} ] . \qquad ( 2 )$$

Modifications to the polarization state by optical elements or a polarization sensitive object can be represented by a 2×2 Jones matrix, M, and the output polarization state follows the linear algebra calculation:

Uₒᵤₜ=M·Uᵢₙ. (3)

The first relevant optical element that the light encounters in the NR-DIC configuration is the birefringent prism that angularly shears the orthogonal polarizations of the illumination. The two states that emerge from the NR-DIC polarization can be represented as ±45° rotations of the input x-polarized beam,

$${\underline{U}}_{+ 45} = exp ( i \frac{{δ}_{bias}}{2} ) {R}_{\underline{\_}} ( + 45 ) \cdot {\underline{U}}_{in} . \\ {\underline{U}}_{- 45} = exp ( i \frac{- {δ}_{bias}}{2} ) {R}_{\underline{\_}} ( - 45 ) \cdot {\underline{U}}_{in} . \qquad ( 4 )$$

where the rotation matrix R (θ) is

$${R}_{\underline{\_}} ( θ ) = [ \begin{matrix}cos θ & - sin θ \\ sin θ & cos θ\end{matrix} ] . \qquad ( 5 )$$

Note, translating a Nomarksi prism laterally across the optical axis of the incident beam adds an average phase bias, δ_{bias}, between the polarization states that leave the prism. Note also that alternate adjustable waveplates can be added to bias the phase with either a Nomarski prism or a Wollaston prism. For example, a liquid crystal waveplate can be used to vary the bias under electrical control. The phase bias is represented by the exponential scalars of ±δ_{bias}/2. What are left are two orthogonal linear polarization states oriented at ±45° to the input x-polarized beam

$$\begin{matrix}{\underline{U}}_{+ 45} = \frac{1}{\sqrt{2}} exp ( i \frac{{δ}_{bias}}{2} ) [ \begin{matrix}1 \\ 1\end{matrix} ] & ( 6 ) \\ {\underline{U}}_{- 45} = \frac{1}{\sqrt{2}} exp ( i \frac{- {δ}_{bias}}{2} ) [ \begin{matrix}1 \\ - 1\end{matrix} ] . & \end{matrix}$$

These two polarization states will be operated on by the quarter-wave retarder (oriented with its optical axis along the x-axis), modified by the polarization dependent properties, if any, at the object and traced back through the quarter-wave retarder to the prism. The ensemble of these polarization operations can be collapsed to an equivalent Jones matrix

M_{System}=M_{QWP}·M_{Object}·M_{QWP}. (7)

A coordinate system convention is used herein in which a reflection from a uniform surface at the object plane is identical to the identity matrix, I. In this convention, the orientation of the optical elements does not reverse for light returning from the object surface. The components of the Jones matrix M_{System} in our coordinate system are

$${{M}_{\underline{\_}}}_{QWP} = [ \begin{matrix}1 & 0 \\ 0 & i\end{matrix} ] \\ {{M}_{\underline{\_}}}_{Object} = {{M}_{\underline{\_}}}_{Attn} {{M}_{\underline{\_}}}_{Phase} . \qquad ( 8 )$$

The object's polarization response is embedded in M_{Object}. The object can selectively attenuate one polarization projection with M_{Attn} or it can add a phase difference between the polarization projections with M_{Phase}. These modifications are a function of the orientation of the object's optical axis, and in general are mathematically:

$${{M}_{\underline{\_}}}_{Attn} = ( \sqrt{R} ) ( ( \frac{1}{2} ( 1 + \sqrt{η} ) ) {I}_{\underline{\_}} + ( \frac{1}{2} ( 1 - \sqrt{η} ) ) {P}_{\underline{\_}} ( 2 {θ}_{Object} ) ) \\ {{M}_{\underline{\_}}}_{Object} = cos ( \frac{{δ}_{Object}}{2} ) {I}_{\underline{\_}} + i sin ( \frac{{δ}_{Object}}{2} ) {P}_{\underline{\_}} ( 2 {θ}_{Object} ) \qquad ( 9 )$$

where P(2θ_{Object}) is called the psuedo-rotation matrix. It is a rotation matrix to account for an arbitrary rotation of the objects polarization axis relative to the global coordinate system and is defined as

$${P}_{\underline{\_}} ( 2 {θ}_{Object} ) = [ \begin{matrix}- cos ( 2 {θ}_{Object} ) & sin ( 2 {θ}_{Object} ) \\ sin ( 2 {θ}_{Object} ) & cos ( 2 {θ}_{Object} )\end{matrix} ] . \qquad ( 10 )$$

The terms of note within these expressions that govern the polarization response of the object are the extinction ratio of any di-attenuation present, \sqrt{η}, and the phase delay of any linear-birefringence present, δ_{object}.

The linear dichroism or di-attenuation variable, η, is defined on the range from 0 to 1, with 0 representing complete di-attenuation (perfect linear polarizer) and 1 representing no di-attenuation.

The linear birefringence parameter, δ_{object}, represents the accumulated phase difference between a field along the material's optical axis and orthogonal to that axis. For an index-of-refraction difference, Δn, between the fields along the optical axis and orthogonal to that axis, the accumulated phase δ_{object}=2πΔn/λ.

The polarization vectors reflected from the object that represent the two angularly sheared polarization states prior to the return trip through the prism are

U_{L}=α_{L}M_{system}·U₊₄₅

U_{R}=α_{R}M_{system}·U₋₄₅. (11)

Note, the effect of any circular dichroism can also be modeled if a scalar constant (α_{L,R}) representing the amount of relative absorption of either the left- or right-circular polarization states at the object is prepended to the appropriate sheared polarization state.

The choice of L and R subscripts are used for sheared polarization vectors which represent light that was left and right circularly polarized in object space, and result in left and right oriented PSFs at the pinhole plane.

If a completely homogenous, perfectly reflecting, non-polarizing object is placed into the Jones calculus, the matrix representing the entire system response for the NR-DIC system M_{System} is the product of the two quarter-wave rotators, M_{System}=M_{QWP}·M_{QWP}. This is identically a half-wave rotator and will rotate the +45° oriented polarization vector to −45° and vice versa for the −45° vector. For these flipped polarization states, the return trip through the DIC prism results in a re-shearing of the component beams. That is, they now have twice the angular shear as they did in the illumination direction. Light that is polarization modified by the object, will have some component that does not get angularly re-sheared, but becomes co-linear with the optical axis; this is what occurs in a standard DIC microscope operating with linear input polarization states. Because of this a-priori knowledge of the redirection properties, the light's return trip through the DIC prism after reflection at the object can be thought of as an analysis by ±45° linear polarizers. Each of the two sheared components returning to the prism are analyzed by each of these DIC prism analyzers. This determines their respective angular direction, and thus their respective position in the pinhole plane of the SRCM. As a result, we have 4 field components

$${\underline{U}}_{L}^{′} = exp ( i \frac{- {δ}_{bias}}{2} ) {{M}_{\underline{\_}}}_{A , - 45} \cdot {{U}_{\underline{\_}}}_{L} \\ {\underline{U}}_{R}^{′} = exp ( i \frac{+ {δ}_{bias}}{2} ) {{M}_{\underline{\_}}}_{A , + 45} \cdot {{U}_{\underline{\_}}}_{R} \\ {\underline{U}}_{C 1}^{′} = exp ( i \frac{- {δ}_{bias}}{2} ) {{M}_{\underline{\_}}}_{A , - 45} \cdot {{U}_{\underline{\_}}}_{R} \\ {\underline{U}}_{C 2}^{′} = exp ( i \frac{+ {δ}_{bias}}{2} ) {{M}_{\underline{\_}}}_{A , + 45} \cdot {{U}_{\underline{\_}}}_{R} . \qquad ( 12 )$$

M_{A,±45} represent linear analyzers oriented at ±45°. The U′_{L} and U′_{R} field vectors are the components that are angularly re-sheared, and U′_{C1} and U′_{C2} are the components that are not re-sheared, but are directed back to the optical axis of the SRCM; the C subscript denotes a center position. The bias translation of the prism is also included. The U′_{L} and U′_{R} field vectors cancel their bias terms as they pick up an the complex conjugate of the phase in their illumination directions. The bias effect on the center components is to double the amount of bias-phase from the illumination direction. Since the center components are colinear along the optical axis, their fields are added

$$\begin{matrix}{U}_{C}^{′} = {U}_{C 1}^{′} + {U}_{C 2}^{′} \\ = exp ( i \frac{- {δ}_{bias}}{2} ) {{M}_{\underline{\_}}}_{A , - 45} \cdot {{U}_{\underline{\_}}}_{R} + \\ exp ( i \frac{+ {δ}_{bias}}{2} ) {{M}_{\underline{\_}}}_{A , + 45} \cdot {{U}_{\underline{\_}}}_{R}\end{matrix} \qquad ( 13 )$$

Standard operation of the NR-DIC mode is under a linear analyzer oriented at 90° to the initial x-linear polarization, M_{A,90}, prior to the pinhole plane. The fields in the left, right, and center positions in the pinhole are then

U_{L,pin}=M_{A,90}·U′_{L}

U_{R,pin}=M_{A,90}·U′_{R}

U_{C,pin}=M_{A,90}·U′_{R} (14)

The shear specifications of the prism chosen to operate the SRCM will govern the overlap of the three PSFs. With no polarization modification by the object, there is no energy in the center distribution, U_{C}. This is the case of a specular object. Using the Jones calculus for the NR-DIC system, the effect of a polarization modification at the object on the pinhole distribution can now be modeled.

Linear Birefringence

Linear birefringence is the differential optical path that light having two orthogonal linear polarizations encounters as it traverses a medium. This occurs because the index-of-refraction of the material is anisotropic (but still homogenous within some region). For convenience only, and not intended to be a limitation on the present disclosure, this discussion and analysis will be restricted to materials that exhibit anisotropy along one axis—so-called “uni-axial materials.” Such materials have a characteristic optical-axis, which is the axis in which the index-of-refraction is different from the other two. The effect of this physical property on the light is to retard or advance the phase of the light's electric field that lies along this optical axis. A common biological material that is known to exhibit birefringence is collagen.

For a linearly-birefringent object, the evolution of the point spread function (“PSF”) at the pinhole using NR-DIC microscopy (wherein the return beams are not entirely recombined) is shown in FIGS. 8A-8D for increasing amounts of phase birefringence. As the amount of birefringent phase increases, a shift occurs in the irradiance distribution. This occurs as more energy is directed to the center PSF. This center PSF is in phase with either the left or right PSF, depending on the angle and sign (±) of the phase birefringence. The conservation of energy between the PSFs is shown in FIGS. 9A-9B along with their phase differences for a range of orientation-angles.

Because the polarization properties of the object vary the distribution of the light in the pinhole along the shear direction, the split-detection structures and methods of the present disclosure can be used to detect such properties. A normalized difference of the integrated irradiance across respective halves of the pinhole along the direction of shear will be used as a metric.

$${S}_{split} = \frac{{S}_{left} - {S}_{right}}{{S}_{left} + {S}_{right}} \qquad ( 15 )$$

This signal is dependent on the angle of the object's optical axis and the strength of its phase difference. For a given amount of phase birefringence, the maximum of this metric will occur when the object's birefringence axis is inclined at 45 degrees to the horizontal or equivalently, along the shear direction. Oriented at this angle, the resultant Sₛₚₗᵢₜ, for increasing phase birefringence is plotted (FIG. 10).

FIGS. 11 and 12 show the effect of rotating a given amount of birefringence, for small and large phase birefringence respectively. The effect of translating the prism and changing the bias-phase (δ_{bias}) between the PSFs is to shift these trends along the x-axis. This is bias, illustrated in FIG. 13. For small amounts of birefringence, the metric calculation is sinusoidal. For larger amounts of birefringence, higher orders of oscillatory components begin to be seen.

Circular Dichroism

Circular dichroism also affects the pinhole signal with this split geometry. Circular dichroism is the differential absorption of left- or right-circular polarized light. The coefficient α_{L}(x,y) and α_{R}(x,y) represent the amount of relative absorption of either the left- or right-circular polarization states, respectively, at an object point (x,y) within the section being imaged. The NR-DIC mode can have both left and circular polarization states incident on the object. These left and right circular states are correlated to the left and right PSFs in the pinhole plane. Differential absorption of one of these states will lead to a biasing effect similar to that of linear birefringence. However, the biasing does not add light to the overlap region; the biasing is caused by the reduce beam irradiance that is a direct result of the decreased reflectance for one of the circular polarizations. Illustrated in FIGS. 14A-14D is the evolution of the irradiance distribution in the pinhole plane when the amount of dichroism is increased. What can be seen is that, different from birefringence, there is no shift in the PSFs, but only a reduction in the irradiance for the PSF that is being absorbed due to circular dichroism at the object. The split pinhole metric is shown in FIG. 15.

Di-Attentuation

A linear dichroism or di-attenuation signal also affects the NR-DIC pinhole signal and irradiance. Di-attenuation is the difference in the absorption/attenuation of electric field along one axis. The strength of this attenuation is characterized by the extinction ratio, η. Di-attenuation is commonly found in sheet polarizers that preferentially absorb one linear polarization state and transmit the orthogonal polarization. In the present discussion, a reflective geometry is considered where light that is back scattered from an object contributes to the signal. In this geometry, di-attenuation refers to the preferential absorption of one electric field component relative to another field component in the backscatter collection geometry; the non-absorbed component has enhanced contribution. The di-attenuation variable, η, is defined on the range from 0 to 1, with 0 representing complete di-attenuation (perfect linear polarizer) and 1 representing no di-attenuation. For this type of polarization effect, the total pinhole irradiance is affected but no left/right biasing occurs. The pinhole evolution for increasing extinction ratio is illustrated in FIG. 16A-16D for di-attenuation in either the x- or y-direction. There is an even redirection of flux to the center channel from either PSF. Thus, for the chosen split-pinhole metric no detectable contrast for linear di-attenuation will be apparent.

FIG. 17 shows the ability to detect di-attenuation when the axis of the di-attenuation is at 45 degrees to the x- or y-axis. In this orientation, di-attenuation redistributes light equally from the left and right spots and increases the light irradiance in the region between the spots. Thus, a three or more detector measurement across the x-axis of the pinhole can detect di-attenuation. Note that unlike optical retardation, the distribution remains left to right symmetrical with the di-attenuation adding light in the center. The amount of central irradiance drops as the di-attenuation axis is rotated away from 45 degrees with respect to the x-axis.

### Exemplary Embodiment

It is possible to extract polarization features from split detectors metrics as described above for each point in the object imaged. Two detectors do not provide sufficient information to differentiate circular dichroism and linear birefringence and cannot differentiate di-attenuation from a reduction in overall reflectance. A three detector system comprising a left detector labeled “L,” a center detector labeled “C,” and a right detector labeled “R,” provides the ability to differentiate circular dichroism and linear birefringence and can differentiate di-attenuation from a reduction in overall reflectance. One possible signal construct for a three-detector system is:

$${S}_{III}^{′} = \frac{L - R}{L + R} + α C ,$$

where α is calibration factor that can be measured from the image of a uniform isotropic surface object such as a glass interface to normalize the S′_{III} parameter to zero in the absence of a polarization based object parameter. Another polarization specific parameter would be to detect a modified split detector metric:

$${S}_{III}^{′} = \frac{L - R}{L + R} .$$

Still another polarization specific parameter would be to detect:

S′″III=L+R−ΔC

where Δ is calibration factor that can be measured from the image of a uniform isotropic surface object such as a glass interface to normalize the S′″_{III} parameter to zero in the absence of a polarization based object parameter. Such a system has the ability collect information from each imaged point in an object to provide an image that is related to the total backscatter collected: S_{III}=L+R+C as well as a polarization sensitive signals S′_{III}, S′_{III} and S′″_{III}.

Considering a four element detector as shown in FIG. 3B where the left most element is labeled “L” for left; the next element is labeled “LC” for left center; the next element is labeled “RC” for right center, and the right most element is labeled “R.” A four element detector provides the ability to differentiate circular dichroism and linear birefringence and can differentiate di-attenuation from a reduction in overall reflectance. One possible signal construct for a four-detector system is

$${S}_{IV}^{′} = \frac{L - R}{L + R} + β ( LC + RC ) ,$$

where β is calibration factor that can be measured from the image of a uniform isotropic surface object such as a glass interface to normalize the S′_{IV} parameter to zero in the absence of a polarization based object parameter. Another polarization specific parameter would be to detect a modified split detector metric:

$${S}_{IV}^{″} = \frac{L - R}{L + R} + \frac{LC - RC}{LC + RC} .$$

Another polarization specific parameter would be to detect a modified split detector metric: S′_{IV}=L+R−ρ(LC+RC), where ρ is calibration factor that can be measured from the image of a uniform isotropic surface object such as a glass interface to normalize the S′″_{IV} parameter to zero in the absence of a polarization based object parameter. Such a system has the ability collect information from each imaged point in an object to provide an image that is related to the total backscatter collected: S_{IV}L+R+LC+RC as well as a polarization sensitive signals S′_{IV}, S″_{IV} and S′″_{IV}.

It is noted that the polarization specific features shift the mathematical moments of the irradiance distribution at the focus of the detector lens. Therefore, polarization information can be extracted by estimating the one-dimensional moments normalized by the number of elements of the irradiance distribution for each imaged point in an object. Consider an n-element sensor where n is even. The optical axis is centered between the n/2 and n/2+1 elements. Moments m=0, 1, . . . n/2 can be calculated. The m^{th} moment Iₘ is:

$${I}_{m} = \frac{{\sum }_{i = 1}^{n} {{S}_{i} ( \frac{- n}{2} + \frac{1}{2} + ( i - 1 ) )}^{m}}{{\sum }_{i = 1}^{n} {( \frac{- n}{2} + \frac{1}{2} + ( i - 1 ) )}^{m} {\sum }_{i = 1}^{n} {S}_{i}} ,$$

where Sᵢ is the i^{th} detector element. Next consider an n-element sensor where n is odd. The optical axis is centered on the n/2+1 element. Moments m=0, 1, . . . (n−1)/2 can be calculated. The m^{th} moment Iₘ is:

$${I}_{m} = \frac{{\sum }_{i = 1}^{n} {{S}_{i} ( \frac{- ( n - 1 )}{2} + ( i - 1 ) )}^{m}}{{\sum }_{i = 1}^{n} {( \frac{- ( n - 1 )}{2} + ( i - 1 ) )}^{m} {\sum }_{i = 1}^{n} {S}_{i}} ,$$

where Sᵢ is the i^{th} detector element. For all n-element sensors the integrated signal

$${\sum }_{i = 1}^{n} {S}_{i}$$

can be obtained for each point in the object.

We note that all the parameters mentioned for two or more sensor element detector that sample the irradiance distribution may be biased by changing phase bias of the Nomarski prism or by utilizing full ellipsometric detection enabled by using a non-polarizating beam splitter combined with a waveplate compensator and adjustable analyzer. Adjusting of the phase bias of the Normarski prism or that of the compensator and/or angle of the analyzer may be done to capture different signatures in success images to elucidate the polarization properties of the object.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. An apparatus for imaging a section of a medium which receives and returns light, the section of the medium having features (“Polarization Sensitive Features”) which return light according to the polarization of the received light, the apparatus comprising:
an optical system for directing light in beams of different polarization in the medium along an optical axis and returning light from the medium, the beams of returned light differentiated according to the light returned from the Polarization Sensitive Features, the optical system comprising:
a birefringent wave plate through which the light and the returned light are transmitted; and
a pinhole lens assembly configured to transmit the returned light through a pinhole aperture; and
a detector configured to receive the returned light from the pinhole lens assembly, the detector having at least two sensors, wherein each sensor is configured to receive a different portion of the returned light and produce an electrical signal in response to the corresponding portion of received light.

2. The apparatus of claim 1, wherein the portion of the returned light received by each sensor of the detector generally corresponds to the differentiation caused by the Polarization Sensitive Features such that the detector is able to differentiate the light returned from the Polarization Sensitive Features.

3. The apparatus of claim 1, further comprising a processor in communication with the detector and configured to generate an image of the section based on the electrical signals of the sensors and including image information of the Polarization Sensitive Features.

4. The apparatus of claim 1, wherein the detector has three sensors

5. The apparatus of claim 1, wherein at least one of the sensors of the detector is configured to receive the portion of the returned light wherein the differentiated beams overlap.

6. The apparatus of claim 1, wherein the electrical signal of each of the sensors is configured to correspond to a polarization parameter of the received light.

7. The apparatus of claim 6, wherein the electrical signal represents an amount and orientation of linear birefringence within the section.

8. The apparatus of claim 6, wherein the electrical signal represents an amount of linear dichroism within the section.

9. The apparatus of claim 6, wherein the electrical signal represents an amount of circular dichroism within the section.

10. A method of imaging a section of a medium which receives and returns light, the section of the medium having features (“Polarization Sensitive Features”) which return light according to the polarization of the received light, the method comprising the steps of:
directing light in beams of different polarization to the medium along an optical axis;
directing beams of light returned from the medium to a detector by way of a birefringement wave plate, the beams of returned light differentiated according to the light returned from the Polarization Sensitive Features;
detecting, using the detector, the returned light, wherein each differentiated beam is detected; and
generating an image of the section from the returned light, the image generated in response to a polarization parameter of the returned light, and the generated image including information of the Polarization Sensitive Features.

11. The method of claim 10, wherein each of the differentiated beams is detected by two or more sensors of the detector, each of the sensors configured to receive a portion of the returned light and produce an electrical signal in response to a corresponding portion of received light.

12. The method of claim 11, wherein the step of detecting the returned light comprises the sub-step of using at least one of the sensors to detect a portion of the returned light wherein the differentiated beams overlap.

13. The method of claim 10, wherein the electrical signal represents an amount and orientation of linear birefringence within the section.

14. The method of claim 10, wherein the electrical signal represents an amount of linear dichroism within the section.

15. The method of claim 10, wherein the electrical signal represents an amount of circular dichroism within the section.
